(19) United States
(12) Patent Application Publication
(10) Pub. No.: US 2026/0116526 A1
(43) Pub. Date: Apr. 30, 2026

(54) Rotary-Wing Aircraft Provided with at least one Multi-Plane Pitch Stabilizer

(71) Applicant: AIRBUS HELICOPTERS, Marignane Cedex (FR)

(72) Inventor: Manousos KELAIDIS, Marseille (FR)

(73) Assignee: AIRBUS HELICOPTERS, Marignane Cedex (FR)

(21) Appl. No.: 19/055,204

(22) Filed: Feb. 17, 2025

(30) Foreign Application Priority Data
Apr. 18, 2024 (FR) 2404015

(51) Int. Cl. B64C 5/02; B64C 3/16; B64C 5/06; B64C 27/04; B64C 27/82

(52) U.S. Cl. CPC B64C 5/02; B64C 3/16; B64C 5/06; B64C 27/04; B64C 27/82; B64C 2027/8254; B64C 2027/8272; B64C 2027/8281

(57) ABSTRACT

An aircraft with a rotary wing, provided with a tail boom carrying a tail fin. The aircraft comprises a pitch stabilization system that is provided with at least one pitch stabilizer comprising a first aerodynamic segment and a second aerodynamic segment. The first aerodynamic segment extends from the tail boom, from a first root section to a first end section, and the second aerodynamic segment extends from the tail fin, from a second root section to a second end section, the first end section being connected directly to the second end section or via a connecting segment.

### CROSS REFERENCE TO RELATED APPLICATION

This application claims priority to French patent application No. FR 24 04015 filed on Apr. 18, 2024, the disclosure of which is incorporated in its entirety by reference herein.

### TECHNICAL FIELD

The present disclosure relates to a rotary-wing aircraft provided with at least one multi-plane pitch stabilizer.

### BACKGROUND

Conventionally, a rotary-wing aircraft may comprise a front airframe carrying at least one rotary wing. The rotary wing enables the aircraft to fly both at high forward speeds and at very low forward speeds, or even allows the aircraft to hover.

A conventional rotary-wing aircraft, such as a helicopter, may further comprise a tail boom extending a front airframe towards the rear, in particular for carrying stabilizing surfaces. Such stabilizing surfaces have the function of ensuring stabilization during forward flight of the movements of the rotorcraft.

In particular, the tail boom conventionally extends from the front airframe to a tail fin that is substantially vertical or slightly inclined relative to the vertical. The concepts of tail boom and tail fin are well known to a person skilled in the art.

A conventional rotary-wing aircraft, and in particular a helicopter, may further comprise a rotor at its rear end. Such a rotor is called a tail rotor, to be distinguished from the rotor forming the rotary wing. The tail rotor is carried by the tail fin. For example, the tail rotor is arranged laterally relative to the tail fin as part of an unducted tail rotor. Alternatively, the tail fin may form a duct delimiting an air flow path wherein the tail rotor is arranged, a ducted tail rotor being known in particular by the brand name Fenestron®.

The tail rotor makes it possible to control the yaw movements of the aircraft, countering to a greater or lesser degree the torque exerted by the rotary wing on the front airframe.

Similarly, regardless of whether the tail rotor is ducted or unducted, the tail fin participates in controlling the yaw movement of the aircraft. Indeed, the tail fin generates a transverse lift during a forward flight. The greater the forward speed of the helicopter, the greater this transverse lift.

Furthermore, a conventional rotary-wing aircraft, and in particular a helicopter, may comprise a pitch stabilization system. A pitch stabilization system comprises one or two pitch stabilizers. Each pitch stabilizer is an offset half-wing. For example, a helicopter comprises two pitch stabilizers disposed symmetrically on either side of the tail boom or tail fin.

Such a pitch stabilizer is sometimes referred to as a “horizontal tail unit”.

According to one example, an aircraft may comprise two pitch stabilizers on either side of the tail fin and forming a T-shaped or inverted T-shaped rear assembly with the tail fin. In another example, an aircraft may comprise a pitch stabilizer forming an L-shaped or inverted L-shaped rear assembly with the tail fin. In another example, the OH 6A helicopter has a Y-shaped rear assembly. According to one example, the CH-1 helicopter comprises a floating tail unit carried by the tail boom.

A pitch stabilizer is generally effective for stabilizing a rotary-wing aircraft, its effectiveness increasing in conjunction with the forward speed of the aircraft. Moreover, the effectiveness of a pitch stabilizer is maximized by maximizing its wing area.

However, on a traditional helicopter, the air passing through the rotating main rotor is deflected backwards during forward movement of the helicopter. This air can impact the pitch stabilization system that tends to make the aircraft pitch up. However, when flight conditions vary, the deflection of the air passing through the rotary wing is also modified. The same therefore applies to the forces possibly exerted on the pitch stabilization system by this air coming from the rotary wing.

When a helicopter remains stationary, the flow of air passing through the rotating rotary wing may not impact a pitch stabilization system or may generate reduced forces on that pitch stabilization system. In the acceleration phase, the airflow is deflected backwards and the forces exerted by the air passing through the rotary wing on the pitch stabilization system increase, and tend to make the helicopter pitch up to a maximum. This phenomenon is known as “attitude hump”. To stabilize the helicopter, the pilot must then use his control stick for the cyclic pitch of the blades of the rotary wing to reduce the pitch up of this helicopter. This maneuver increases the workload on the pilot and the power required to set the rotary wing in motion. As the forward speed of the helicopter increases, the airflow from the rotary wing returns to the forward axis and so flows over the pitch stabilization system and thus no longer induces this attitude hump phenomenon. The attitude hump can further complicate a landing by reducing a pilot's visibility due to pitch-up of the aircraft.

Furthermore, it is understood that the optimization of a pitch stabilizer carried out by maximizing its wing area accentuates the attitude hump.

Document EP 1547919 describes a helicopter having two pitch stabilizing surfaces extending symmetrically on either side of an anteroposterior plane. These stabilizing surfaces may be horizontal, being orthogonal to the anteroposterior plane for example, or may jointly describe a V-shape by having an angle of between 0° and 90° with said anteroposterior plane. Each pitch stabilizing surface can be equipped with a flap.

Documents U.S. Pat. No. 2,369,652 and GB 606420 relate to a rotary-wing aircraft provided with an upper pitch stabilization surface and a lower pitch stabilization surface.

Document EP 2409917 A1 is also known.

Documents US2024/034465 A1, US2015/307182 A1, and U.S. Pat. No. 5,503,352 A1 are also known.

### SUMMARY

An object of the present disclosure is therefore to propose a rotary-wing aircraft provided with at least one innovative pitch stabilizer that makes it possible to reduce the attitude hump and/or the negative lift at low speed.

The disclosure thus relates to a rotary-wing aircraft provided with a tail boom carrying a tail fin, the aircraft comprising a tail rotor carried by the tail fin, the tail rotor being able to move in rotation about a rotor axis and having a rotor diameter, a vertical-longitudinal plane passing through the tail boom transversely separating a first side from a second side of the aircraft, the aircraft comprising a pitch stabilization system that is provided with at least one pitch stabilizer that extends on the first side or on the second side, said pitch stabilizer comprising a first aerodynamic segment and a second aerodynamic segment.

For example, the first aerodynamic segment and the second aerodynamic segment comprise a succession of sections that each extend longitudinally from a trailing edge to a leading edge, and in thickness from a bottom face to a top face. Each section is a slice of the segment concerned, for example in a plane parallel to the roll axis and to the yaw axis of the aircraft.

The rotor diameter is in fact equal to twice the distance separating the free end of the tail rotor blades from the axis of rotation of the tail rotor.

Furthermore, the first aerodynamic segment extends spanwise from the tail boom, from a first root section to a first end section, and the second aerodynamic segment extends spanwise from the tail fin, from a second root section to a second end section, the first end section being connected directly to the second end section or via a connecting segment.

Since an aircraft can achieve various inclinations in roll and pitch in flight, the expression “vertical-longitudinal plane” means that this plane is vertical when the aircraft is landed on a horizontal area.

As a result, the one or more pitch stabilizers each comprise at least two aerodynamic planes formed respectively by the first aerodynamic segment and the second aerodynamic segment, or even a third plane formed by the connecting segment. The first aerodynamic segment and the second aerodynamic segment form offset half-wings. The first aerodynamic segment and the second aerodynamic segment of the same pitch stabilizer are on the first side, or the first aerodynamic segment and the second aerodynamic segment of the same pitch stabilizer are on the second side of the aircraft. In forward flight, each aerodynamic segment produces a negative lift tending to balance the aircraft, in pitch in particular.

A conventional single-plane pitch stabilizer may be impacted at low speeds by air passing through the rotary wing and may generate a large pitch angle that the pilot must compensate for. This pitch angle may increase as the forward speed of the aircraft increases, up to a maximum angle and then decreases. The curve presenting the nose-up pitch angle induced relative to the forward speed forms a hump, which explains why this phenomenon is sometimes referred to as an “attitude hump”.

Conversely, instead of using such a single-plane pitch stabilizer, the disclosure proposes a multi-plane pitch stabilizer comprising a first aerodynamic segment and a second aerodynamic segment or even a connecting segment. The first aerodynamic segment is carried by the tail boom while the second aerodynamic segment is carried by the tail fin and is therefore offset longitudinally or even vertically from the first aerodynamic segment. The first aerodynamic segment and the second aerodynamic segment are optionally not vertically aligned with each other. The second aerodynamic segment may, in particular, comprise a second root section located at least partially below, above or behind the tail rotor, either longitudinally behind the first aerodynamic segment with regard to the direction of forward travel of the aircraft or even vertically in a horizontal plane located above or below the first aerodynamic segment. The first aerodynamic segment and the second aerodynamic segment tend to jointly generate, in forward flight, a negative lift substantially equivalent to a conventional single-plane stabilizer. On the other hand, the use of two aerodynamic pitch stabilization sections offset from one another, in particular longitudinally, due to their respective locations on the tail boom and the tail fin, tends to reduce the attitude hump compared to a conventional aircraft.

Indeed, the first aerodynamic segment and the second aerodynamic segment are offset from one another so that the air flow passing through the rotary wing and deflected towards the pitch stabilizer exerts different pressures on the first aerodynamic segment and the second aerodynamic segment as a function of the forward speed. The two aerodynamic segments are sufficiently offset from each other, due to their locations, to be impacted differently, if applicable, at each instant and at low speeds, by the airflow coming from the rotary wing.

Under the effect of the pressure of the air passing through the rotary wing, the first aerodynamic segment and the second aerodynamic segment individually tend to generate a maximum nose-up pitch angle that is actually smaller than the maximum pitch angle reached with a conventional single-plane stabilizer. Indeed, the wing area of each aerodynamic segment is smaller than the wing area of a conventional single-plane stabilizer, the sum of the wing areas of the two aerodynamic segments being able to be substantially equivalent to the wing area of a conventional single-plane stabilizer. Furthermore, the maximum forces exerted on each aerodynamic segment of a pitch stabilizer according to the disclosure are achieved at de facto different forward speeds due to the longitudinal offset of the first and second aerodynamic segments.

At each instant, the first aerodynamic segment and the second aerodynamic segment then jointly generate a reduced attitude hump compared to a conventional system. In a pictorial manner, instead of having a large attitude hump, the disclosure makes it possible to obtain two small attitude humps reached at different forward speeds, these two attitude humps jointly generating a reduced overall attitude hump compared to a single-plane system.

For a given wing area, the disclosure significantly reduces the attitude hump phenomenon compared to a conventional helicopter. Consequently, the disclosure improves firstly the performance of the aircraft since the rotary wing requires less power in order to compensate for the attitude hump, and secondly the safety of flights during critical approach or landing phases.

The aircraft may also comprise one or more of the following features, taken individually or in combination, that make it possible in particular to optimize the operation of the aircraft.

Depending on the stabilization to be provided, the aircraft may comprise two so-called pitch stabilizers according to the disclosure, arranged on either side of the vertical-longitudinal plane.

Unlike a conventional system comprising two horizontal planes arranged transversely on either side of a tail boom for example, this variant proposes two multi-plane stabilizers.

For example, the two pitch stabilizers are symmetrical with respect to the vertical-longitudinal plane.

According to another possibility, the aircraft may comprise a single pitch stabilizer according to the disclosure, disposed on the first side, and a single stabilization surface disposed on the second side.

A pitch stabilizer according to the disclosure may optionally be associated with a conventional fixed plane or one having reduced dimensions.

According to one possibility compatible with the preceding possibilities, the first aerodynamic segment can be arranged longitudinally in the first third of the tail boom starting from the tail fin.

The first aerodynamic segment can be carried by the tail boom in the vicinity of the tail fin. For example, the first aerodynamic segment can be arranged substantially at the same location as a conventional tail unit. On the other hand, the second aerodynamic segment is carried by the tail fin in order to be moved away from the first aerodynamic segment and to be impacted differently by the flow passing through the rotary wing for the same forward speed.

According to one possibility compatible with the preceding possibilities, the tail rotor can be disposed laterally with respect to the tail fin or in an air flow path delimited by the tail fin.

According to one possibility compatible with the preceding possibilities, a first quarter-chord line of the first aerodynamic segment at the tail boom can be longitudinally separated from a vertical-transverse rotor plane containing the rotor axis by a first longitudinal distance of between 0.7 times the rotor diameter inclusive and twice the rotor diameter inclusive.

Since an aircraft can achieve various inclinations in roll and pitch in flight, the expression “vertical-transverse rotor plane” means that this plane is vertical when the aircraft is landed on a horizontal area. In other words, the first longitudinal distance corresponds to the distance, in a horizontal plane, separating the quarter-chord point of the first root section and the vertical-transverse rotor plane.

It should be remembered that the concept of a quarter-chord line is known to a person skilled in the art. Each aerodynamic segment is an aerodynamic member that usually comprises a succession of sections along its span. The chord of a section represents the length of the straight-line segment connecting the leading edge to the trailing edge of that section, the quarter-chord line passing through the quarter of this segment starting from the leading edge.

This feature can adjust the nose-up pitch angle generated by the pitch stabilization system, while minimizing aerodynamic interactions with the tail rotor.

According to one possibility compatible with the preceding possibilities, a second quarter-chord line of the second aerodynamic segment at the tail fin may be longitudinally separated from a vertical-transverse rotor plane containing the rotor axis, by a second longitudinal distance of between 0.6 times the rotor diameter inclusive and the rotor diameter inclusive, or even less than the first longitudinal distance.

In other words, the second longitudinal distance corresponds to the distance, in a horizontal plane, separating the quarter-chord point of the second root section and the vertical-transverse rotor plane.

This feature can adjust the nose-up pitch angle generated by the pitch stabilization system, while minimizing the interactions with the tail rotor.

According to one possibility compatible with the preceding possibilities, a second quarter-chord line of the second aerodynamic segment at the second root section can be positioned in azimuth with respect to the rotor axis in an angular range from −30° inclusive to +180° inclusive, with a position at 0° reached horizontally facing the point of the tail rotor furthest away longitudinally from the tail boom and a position at +90° located vertically above a position at −90°.

This feature can adjust the nose-up pitch angle generated by the pitch stabilization system, while minimizing the interactions with the tail rotor.

For example, the tail rotor can be disposed in an air flow path delimited by the tail fin, the second root section of the second aerodynamic segment being arranged at least partially above the air flow path, the second aerodynamic segment having a negative dihedral and a forward sweep, the first aerodynamic segment having a positive dihedral and a rearward sweep and being connected to the second aerodynamic segment by the connecting segment, the second quarter-chord line of the second aerodynamic segment at the second root section being positioned in azimuth with respect to the rotor axis within an angular range ranging from +90° inclusive to +180° inclusive.

Such a feature tends to minimize interactions with the tail rotor.

According to one possibility compatible with the preceding possibilities, when the first end section is connected to the second end section via the connecting segment, the connecting segment may be curved and have an average curvature varying between 0.02 times the rotor diameter inclusive and 0.4 times the rotor diameter inclusive.

Alternatively, since the first end section can be connected to the second end section via the connecting segment, the connecting segment can extend in an inclined plane, this inclined plane extending from the first end section to the second end section, this inclined plane having an inclination less than or equal to 30° with respect to a vertical axis when the aircraft is at rest on a horizontal area.

Thus, the connection segment may be vertical or almost vertical.

According to one possibility compatible with the preceding possibilities, the first aerodynamic segment and the second aerodynamic segment can have a taper rate between 0.6 inclusive and 1.2 inclusive, the first aerodynamic segment and the second aerodynamic segment having a chord that varies moving away from the tail boom/tail fin assembly, linearly or non-linearly or linearly per segment.

Each aerodynamic segment extending from a root section present at the tail boom or tail fin to an end section, optionally connected to the connecting segment, the taper rate may be equal to the quotient of the chord at the root section and the chord at the end section.

According to one possibility, the leading edges and the trailing edges of the first aerodynamic segment and the second aerodynamic segment may each describe a straight-line segment.

According to one possibility compatible with the preceding possibilities, the first aerodynamic segment may have a rearward sweep with a sweep angle of between 10° inclusive and 60° inclusive, the second aerodynamic segment having a forward sweep with a sweep angle of between −10° inclusive and −60° inclusive.

This feature tends to give a triangular shape to the pitch stabilizer seen from above. This feature tends to minimize the attitude hump by judiciously positioning the first aerodynamic segment relative to the second aerodynamic segment.

According to one possibility compatible with the preceding possibilities, the first aerodynamic segment may have a positive dihedral of between 0° inclusive and 60° inclusive, the second aerodynamic segment having a negative dihedral of between 0° inclusive and −60° inclusive.

This feature tends to give a triangular shape to the pitch stabilizer seen from behind. This feature tends to minimize the attitude hump by judiciously positioning the first aerodynamic segment relative to the second aerodynamic segment.

According to one possibility compatible with the preceding possibilities, the trailing edge at the first root section can be separated: i) longitudinally and seen from above, from the leading edge at the second root section by a longitudinal distance of between 0.5 m (0.5 meter) inclusive and 2.5 m inclusive, and ii) vertically and seen from a position behind the aircraft, by a height of between −1 m (minus one meter) inclusive and 2 m inclusive, starting from the first aerodynamic segment and considering that the height is positive when the second aerodynamic segment is present in a horizontal plane located above the first aerodynamic segment when the aircraft is at rest on a horizontal area.

The expression “longitudinally separated and viewed from above” means that a first vertical-transverse plane passing through the trailing edge at the first root section is longitudinally separated from a second vertical-transverse plane, passing through the leading edge at the second root section and parallel to the first vertical-transverse plane, by a longitudinal distance of between 0.5 m inclusive and 2.5 m inclusive.

Similarly, a horizontal plane passing through the trailing edge at the first root section is separated from a horizontal plane passing through the leading edge at the second root section by a height of between −1 m inclusive and 2 m inclusive in a direction moving away from the ground.

This feature tends to minimize the attitude hump by judiciously positioning the first aerodynamic segment relative to the second aerodynamic segment, or even may tend to limit interactions with the tail rotor if applicable.

### BRIEF DESCRIPTION OF THE DRAWINGS

The disclosure and its advantages appear in greater detail from the following description of examples given by way of illustration with reference to the accompanying figures, wherein:

FIG. 1 is a side view of an aircraft according to the disclosure, having a ducted tail rotor;

FIG. 2 is a side view of a rear assembly of an aircraft according to the disclosure, having an unducted tail rotor;

FIG. 3 is a schematic view of a pitch stabilization system according to the disclosure;

FIG. 4 is a rear view of the pitch stabilization system of FIG. 3;

FIG. 5 is a side view of the pitch stabilization system of FIG. 3;

FIG. 6 is a rear view of a pitch stabilization system according to the disclosure;

FIG. 7 is a rear view of a pitch stabilization system according to the disclosure; and

FIG. 8 is a diagram explaining the disclosure.

### DETAILED DESCRIPTION

Elements present in more than one of the figures are given the same references in each of them.

Three mutually orthogonal directions X, Y, and Z are indicated in some of the figures.

The first direction X is referred to as longitudinal. The term “longitudinal” relates to any direction parallel to the first direction X.

The second direction Y is referred to as transverse. The term “transverse” relates to any direction parallel to the second direction Y.

Finally, the third direction Z is referred to as in elevation. The expression “in elevation” relates to any direction parallel to the third direction Z.

The expression “longitudinal distance” associated with two points designates a distance between two vertical planes when the aircraft is at rest on a horizontal area, these two planes containing two transverse axes passing through these two points.

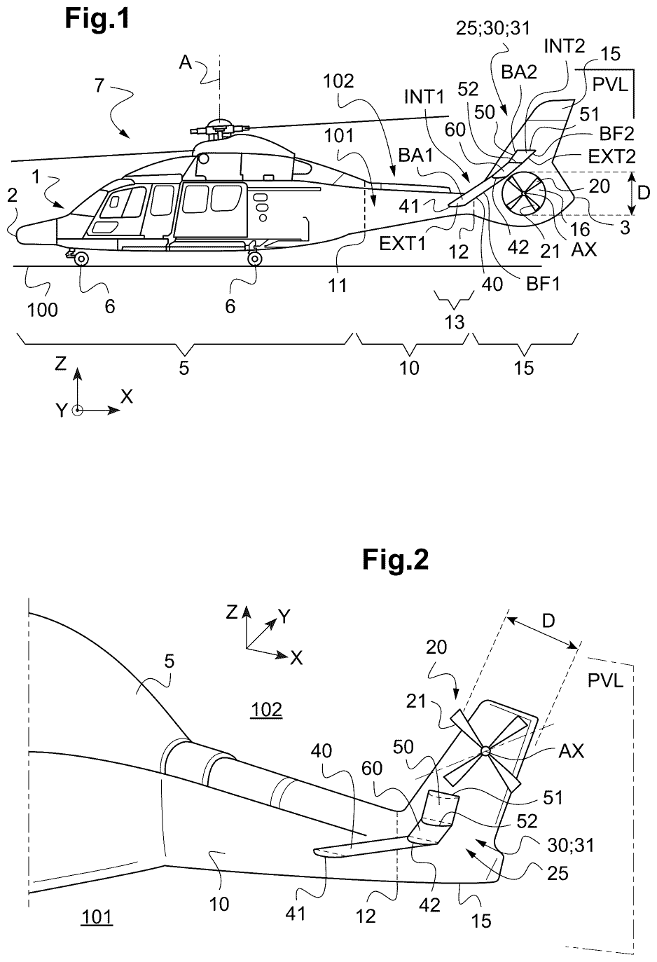

FIG. 1 shows an aircraft 1 with a rotary wing 7, according to the disclosure. This aircraft 1 extends along a roll axis parallel to the first direction X from a nose 2 to a rear end 3, in elevation along a yaw axis parallel to the third direction Z from a landing gear to an apex, and transversely from a first side 101 to a second side 102, along a pitch axis parallel to the second direction Y.

In particular, this aircraft 1 comprises a tail boom 10 carrying a tail fin 15. A vertical-longitudinal plane PVL passing through the tail boom 10, transversely separates the first side 101 from the second side 102 of the aircraft 1. This vertical-longitudinal plane PVL is vertical when the aircraft 1 rests on a horizontal area 100 and extends from the nose 2 to the rear end 3. This vertical-longitudinal plane PVL contains, for example, the yaw axis and the roll axis of the aircraft 1.

The tail boom 10 may extend rearwards a front airframe 5 carrying the rotary wing 7. The front airframe 5 rests on the ground via a landing gear 6. Consequently, the tail boom 10 may extend from a front section 11 connected to the front airframe 5 to a rear section 12 connected to the tail fin 15.

The aircraft 1 further comprises a tail rotor 20 carried by the tail fin 15. The tail rotor 20 is provided with a plurality of blades 21 that are jointly movable in rotation about a rotor axis AX. The free ends of the blades describe a circle with a rotor diameter D.

According to the example in FIG. 1, the tail rotor 20 may be a ducted rotor arranged in an air flow path 16 delimited by the tail fin 15.

According to the example in FIG. 2, the tail rotor 20 may be an unducted rotor carried by the tail fin 15 while being transversely offset with respect to this tail fin 15.

Regardless of the embodiment and with reference again to FIG. 1, the aircraft 1 comprises a pitch stabilization system 25.

The pitch stabilization system 25 is provided with one or more pitch stabilizers 30 according to the disclosure. For the sake of clarity, the expression “each pitch stabilizer 30” is used hereinafter in the presence of one or more pitch stabilizers. Reference 30 can designate any pitch stabilizer according to the disclosure, while references 31, 32 designate particular stabilizers if necessary.

Each pitch stabilizer 30 extends either from the first side 101 or the second side 102.

Each pitch stabilizer 30 comprises a first aerodynamic segment 40 and a second aerodynamic segment 50.

The first aerodynamic segment 40 comprises a plurality of first aerodynamically profiled sections along its span. Each first profiled section extends longitudinally from a first trailing edge BF1 to a first leading edge BA1, i.e., substantially parallel to the vertical-longitudinal plane PVL. In addition, each first section of the first aerodynamic segment 40 extends in thickness from a first lower face EXT1 to a first upper face INT1. Similarly, the second aerodynamic segment 50 comprises, spanwise, a plurality of second aerodynamically profiled sections that extend longitudinally from a second trailing edge BF2 to a second leading edge BA2 and in thickness from a second lower face EXT2 to a second upper face INT2.

In particular, the first aerodynamic segment 40 extends spanwise from the tail boom 10, from a first root section 41 to a first end section 42. For example, the first aerodynamic segment 40 is disposed longitudinally in the first third 13 of the tail boom 10 starting from the tail fin 15.

Conversely, the second aerodynamic segment 50 extends spanwise from the tail fin 15, from a second root section 51 to a second end section 52.

The first end section 42 is connected directly to the second end section 52 or via a connecting segment 60 according to the example in FIG. 1.

Consequently, the first aerodynamic segment 40 and the second aerodynamic segment 50 are offset from each other and differently impacted by the air flow passing through the rotary wing 4 during its rotation for the same forward speed.

Furthermore, the first aerodynamic segment 40 and/or the second aerodynamic segment 50 may comprise profiled sections having conventional aerodynamic profiles, for example but not necessarily of the NACA or OA type.

Optionally, the first aerodynamic segment 40 and/or the second aerodynamic segment 50 may comprise conventional members for adjusting the cruising attitude, such as stationary flaps referred to as “tabs” making it possible to locally increase the chord of a segment of a stabilizer, or referred to as “Gurney tabs”.

Optionally, the first aerodynamic segment 40 and/or the second aerodynamic segment 50 may comprise a corrugated trailing edge of the type called a “wavy trailing edge” or a member called a “splitter” for reducing drag.

Optionally, the first aerodynamic segment 40 and/or the second aerodynamic segment 50 may comprise a leading edge known as a “slat” for improving aerodynamic performance in flight during a rapid climb.

Optionally, the first aerodynamic segment 40 and/or the second aerodynamic segment 50 may comprise at least one active movable flap for adjusting the balance during cruising.

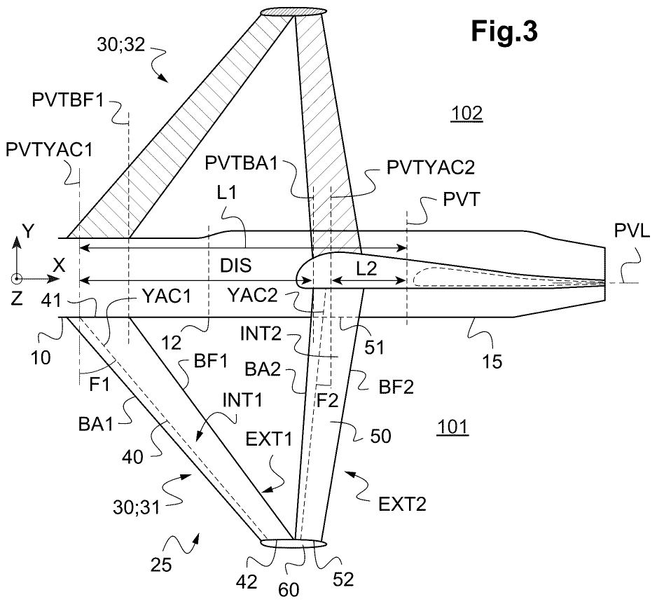

FIGS. 3 to 7 show at least one pitch stabilizer 30.

Regardless of the number of pitch stabilizers 30, the first aerodynamic segment 40 of a pitch stabilizer 30 according to the disclosure may be located at a first longitudinal distance L1 from the rotor axis AX, i.e., in top view, of between 0.7 times the rotor diameter D inclusive and twice the rotor diameter D inclusive.

More precisely, a first quarter-chord line YAC1 of the first aerodynamic segment 40 in the first root section 41 is longitudinally separated from a vertical-transverse rotor plane PVT containing the rotor axis AX by the first longitudinal distance L1, optionally between 0.7 times the rotor diameter D inclusive and twice the rotor diameter D inclusive. The vertical-transverse rotor plane PVT is a plane containing the rotor axis AX that is vertical when the aircraft is at rest on a horizontal area 100.

The second aerodynamic segment 50 may be located at a second longitudinal distance L2 from the rotor axis AX, i.e., in top view, between 0.6 times the rotor diameter D inclusive and the rotor diameter D inclusive.

More precisely, a second quarter-chord line YAC2 of the second aerodynamic segment 50 in the second root section 51 is longitudinally separated from the vertical-transverse rotor plane PVT by a second longitudinal distance L2 of between 0.6 times the rotor diameter D inclusive and the rotor diameter D inclusive.

Furthermore, the trailing edge BF1 at the first root section 41 may be separated from the leading edge BA2 at the second root section 51 by a longitudinal distance DIS of between 0.5 m inclusive and 2.5 m inclusive. In other words, a vertical/transverse trailing edge plane PVTBF1 containing the first trailing edge BF1 at the first root section 41 and vertical when the aircraft is at rest on a horizontal area 100 is separated by the longitudinal distance DIS from a vertical/transverse leading edge plane P PVTBA2 containing the second leading edge BA2 at the second root section 51, and vertical.

According to another aspect, the first aerodynamic segment 40 and the second aerodynamic segment 50 optionally have a taper rate between 0.6 inclusive and 1.2 inclusive, the first aerodynamic segment 40 and the second aerodynamic segment 50 each having respective chords that vary moving away from the tail boom/tail fin assembly, linearly or non-linearly or linearly per segment.

According to the example shown in FIG. 3, the chords of the first aerodynamic segment 40 and the second aerodynamic segment 50 decrease linearly as they move away from the tail boom/tail fin assembly.

In another aspect, the first aerodynamic segment 40 has a rearward sweep. The first aerodynamic segment 40 is therefore inclined towards the rear of the aircraft 1. For convenience, a sweep angle is considered positive in the presence of a rearward sweep and negative in the presence of a forward sweep.

This first aerodynamic segment 40 thus has a first sweep angle F1 of between 10° inclusive and 60° inclusive. For example, the first sweep angle is measured between a first vertical-transverse plane PVTYAC1 orthogonal to the vertical-longitudinal plane PVL and passing through the quarter-chord of the first root section 41 and a median quarter-chord line YAC1 with respect to the quarter-chord of each section.

Conversely, the second aerodynamic segment 50 has a forward sweep. The second aerodynamic segment 50 then has a sweep angle F2 of between −10° inclusive and −60° inclusive. For example, the second sweep angle is measured between a second vertical-transverse plane PVTYAC2 orthogonal to the vertical-longitudinal plane PVL and passing through the quarter-chord of the second root section 51 and a median quarter-chord line YAC2 with respect to the quarter-chord of each section.

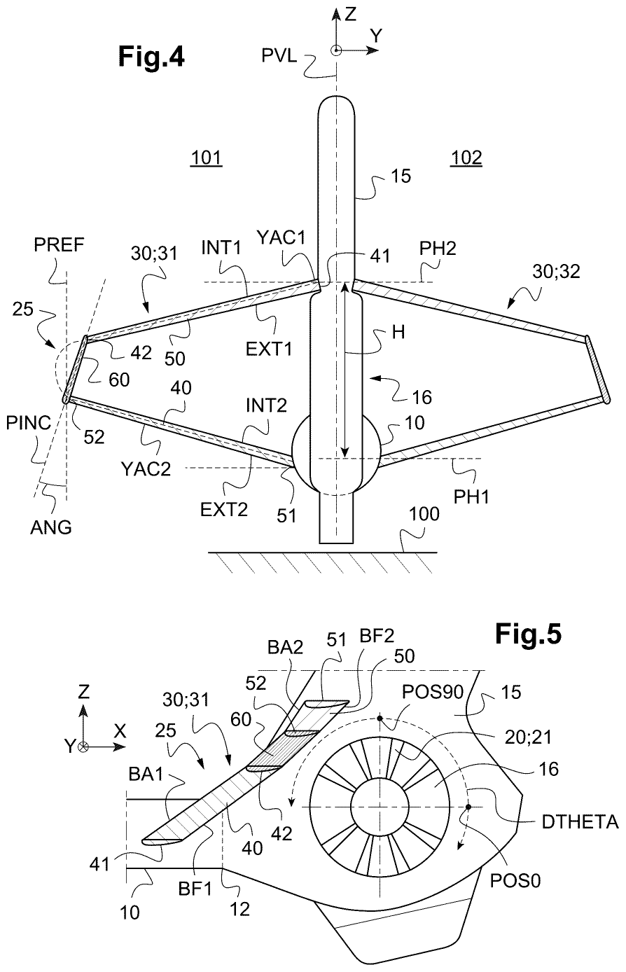

According to another aspect and with reference to FIG. 4, the first trailing edge BF1 at the first root section 41 is vertically separated from the second leading edge BA2 at the second root section 51 by a height H of between −1 m inclusive and 2 m inclusive starting from the first aerodynamic segment 40. In other words, the height H separates a first horizontal plane PH1, that is horizontal when the aircraft 1 is at rest on a horizontal area 100 and passes through the first trailing edge BF1 at the first root section 41, and a second horizontal plane PH2, that is horizontal and passes through the second leading edge BA2 of the second root section 51. The height is considered positive when the second horizontal plane is above the first horizontal plane.

In another aspect, the first aerodynamic segment 40 has a positive dihedral of between 0° and 60°, the second aerodynamic segment 50 having a negative dihedral of between 0° and −60°. A dihedral angle is usually denoted as positive when the section concerned tends to rise moving away from its root. The dihedral angles can be measured, for example, with respect to the quarter-chord lines mentioned above.

In another aspect, in the presence of a connecting segment 60, the connecting segment 60 may be vertical or almost vertical. This connecting segment 60 then extends in an inclined plane PINC going from the first end section 42 to the second end section 52. For example, this inclined plane PINC has an inclination PREF less than or equal to 30° with a vertical axis PREF when the aircraft 1 is at rest on a horizontal area 100.

According to the example illustrated with dotted lines in FIG. 4, the connecting segment 60 is curved and has an average curvature varying between 0.02 times the rotor diameter D inclusive and 0.4 times the rotor diameter D inclusive.

According to another aspect and with reference to FIG. 5, the second quarter-chord line of the second aerodynamic segment 50 at the second root section 51 is positioned in azimuth with respect to the rotor axis AX in an angular range DTHETA from −30° inclusive to +180° inclusive, with a position POS0 at 0° reached horizontally facing the point of the tail rotor 20 furthest away longitudinally from the tail boom 10 and a position POS90 at +90° located vertically above a position at −90°. The position POS0 is thus closer to the rear end 3 of the aircraft than the position POS180 reached at +180°.

Furthermore, according to the embodiment of FIGS. 3 to 5, the tail rotor 20 is disposed in an air flow path 16 delimited by the tail fin 15. The second root section 51 of the second aerodynamic segment 50 of a stabilizer 30 according to the disclosure is in addition arranged above the air flow path 16. Moreover, the second aerodynamic segment 50 has a negative dihedral and a forward sweep, while the first aerodynamic segment 40 has a positive dihedral and a rearward sweep. The first aerodynamic segment 40 may also be connected to the second aerodynamic segment 50 by the connecting segment 60. Finally, the second quarter-chord line of the second aerodynamic segment 50 at the second root section 51 may be positioned in azimuth relative to the rotor axis AX in an angular range DTHETA ranging from +90° inclusive to +180° inclusive.

According to FIGS. 3 to 5, the aircraft 1 comprises two pitch stabilizers 31, 32 arranged on either side of the vertical-longitudinal plane PVL. For example, the two pitch stabilizers 31, 32 are symmetrical with respect to the vertical-longitudinal plane PVL.

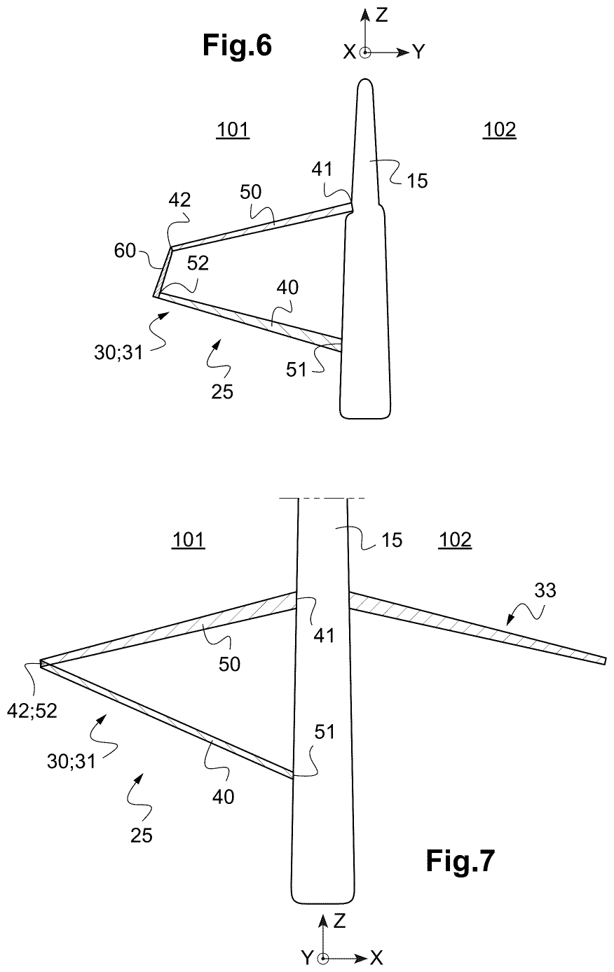

According to FIG. 6, the pitch stabilization system 25 comprises only one pitch stabilizer 31.

According to FIG. 7, the pitch stabilization system 25 comprises a single pitch stabilizer 31 disposed on the first side 101, and a single stabilization surface 33 disposed on the second side 102.

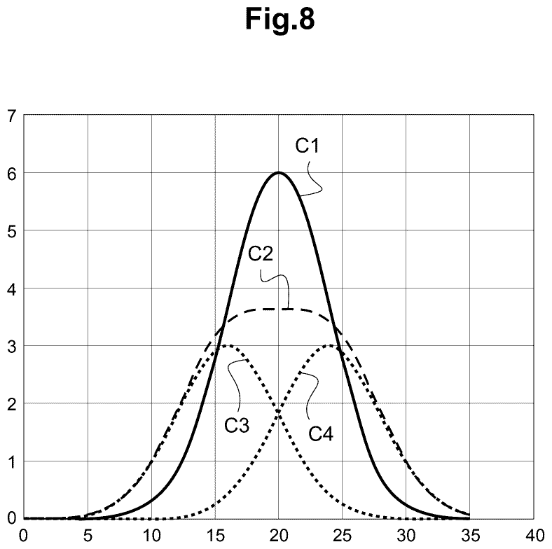

Regardless of the embodiment, FIG. 8 shows the operation of a pitch stabilizer of the disclosure.

This FIG. 8 shows a diagram comprising, on the y-axis, a pitch-up angle of the aircraft 1, and, on the x-axis, a forward speed of the aircraft 1.

Curve C1 illustrates the pitch-up angle obtained with a single-plane stabilizer having a given wing area. Curve C2 shows the pitch-up angle obtained with a stabilizer C2 having this same wing area distributed between the first aerodynamic segment 40 and the second aerodynamic segment 50. Curve C3 illustrates the pitch-up angle that would be obtained with the first aerodynamic segment 40 alone and curve C4 illustrates the pitch-up angle that would be obtained with the second aerodynamic segment 50 alone.

Curve C1 has a large attitude hump reaching a maximum for a speed of 20 knots. On the other hand, the first aerodynamic segment 40 and the second aerodynamic segment 50 generate humps having on the one hand smaller amplitudes than that of the curve C1 but also shifted in forward speeds. Thus, a multi-plane pitch stabilizer according to the disclosure tends to generate, at low speeds, a substantially smaller maximum pitch angle than with a conventional single-plane stabilizer.

Naturally, the present disclosure may be subjected to numerous variations as to its implementation. Although several embodiments are described above, it should readily be understood that it is not conceivable to identify exhaustively all the possible embodiments. It is naturally possible to replace any of the means described with equivalent means without going beyond the ambit of the present disclosure.

For example, the embodiments of FIGS. 3 to 6 could comprise a first aerodynamic segment 40 directly connected to the second aerodynamic segment 50. Conversely, the embodiment shown in FIG. 7 could comprise a first aerodynamic segment 40 connected to the second aerodynamic segment 50 via a connecting segment 60.

What is claimed is:

1. A rotary-wing aircraft provided with a tail boom carrying a tail fin, the aircraft comprising a tail rotor carried by the tail fin, the tail rotor being able to rotate about a rotor axis and having a rotor diameter, a vertical-longitudinal plane passing through the tail boom transversely separating a first side from a second side of the aircraft, the aircraft comprising a pitch stabilization system that is provided with at least one pitch stabilizer that extends on the first side or on the second side, the pitch stabilizer comprising a first aerodynamic segment and a second aerodynamic segment,
wherein the first aerodynamic segment extends spanwise from the tail boom, from a first root section to a first end section, and the second aerodynamic segment extends spanwise from the tail fin, from a second root section to a second end section, the first end section being connected directly to the second end section or via a connecting segment, a first quarter-chord line of the first aerodynamic segment in the first root section being longitudinally separated from a vertical-transverse rotor plane containing the rotor axis by a first longitudinal distance between 0.7 times the rotor diameter and twice the rotor diameter.

2. The aircraft according to claim 1,
wherein the aircraft comprises two pitch stabilizers arranged on either side of the vertical-longitudinal plane.

3. The aircraft according to claim 2,
wherein the two pitch stabilizers are symmetrical with respect to the vertical-longitudinal plane.

4. The aircraft according to claim 1,
wherein the aircraft comprises a single pitch stabilizer disposed on the first side, and a single stabilizing surface disposed on the second side.

5. The aircraft according to claim 1,
wherein the first aerodynamic segment is arranged longitudinally in the first third of the tail boom starting from the tail fin.

6. The aircraft according to claim 1,
wherein a second quarter-chord line of the second aerodynamic segment in the second root section is longitudinally separated from the vertical-transverse rotor plane by a second longitudinal distance between 0.6 times the rotor diameter inclusive and the rotor diameter inclusive.

7. The aircraft according to claim 1,
wherein a second quarter-chord line of the second aerodynamic segment at the second root section is positioned in azimuth with respect to the rotor axis in an angular range from −30° inclusive to +180° inclusive, with a position at 0° reached horizontally facing the point of the tail rotor furthest away longitudinally from the tail boom and a position at +90° located vertically above a position at −90°.

8. The aircraft according to claim 7,
wherein the tail rotor is disposed in an air flow path delimited by the tail fin, the second root section of the second aerodynamic segment being arranged at least partially above the air flow path, the second aerodynamic segment having a negative dihedral and a forward sweep, the first aerodynamic segment having a positive dihedral and a rearward sweep and being connected to the second aerodynamic segment by the connecting segment, the second quarter-chord line of the second aerodynamic segment at the second root section being positioned in azimuth with respect to the rotor axis within an angular range ranging from +90° inclusive to +180° inclusive.

9. The aircraft according to claim 1,
wherein the first end section being connected to the second end section via the connecting segment, the connecting segment is curved and has an average curvature varying between 0.02 times the rotor diameter inclusive and 0.4 times the rotor diameter inclusive.

10. The aircraft according to claim 1,
wherein the first end section being connected to the second end section via the connecting segment, the connecting segment extends in an inclined plane, this inclined plane extending from the first end section to the second end section, this inclined plane having an inclination less than or equal to 30° with respect to a vertical axis when the aircraft is at rest on a horizontal area.

11. The aircraft according to claim 1,
wherein the first aerodynamic segment and the second aerodynamic segment have a taper rate between 0.6 inclusive and 1.2 inclusive, the first aerodynamic segment and the second aerodynamic segment having a chord that varies moving away from the tail boom/tail fin assembly, linearly or non-linearly or linearly per segment.

12. The aircraft according to claim 1,
wherein the first aerodynamic segment has a rearward sweep with a sweep angle of between 10° inclusive and 60° inclusive, the second aerodynamic segment having a forward sweep with a sweep angle of between −10° inclusive and −60° inclusive.

13. The aircraft according to claim 1,
wherein the first aerodynamic segment has a positive dihedral of between 0° inclusive and 60° inclusive, the second aerodynamic segment having a negative dihedral of between 0° inclusive and −60° inclusive.

14. The aircraft according to claim 1,
wherein a trailing edge at the first root section is separated: i) longitudinally and seen from above, from a leading edge at the second root section by a longitudinal distance of between 0.5 m inclusive and 2.5 m inclusive, and ii) vertically and seen from a position behind the aircraft, by a height of between −1 m inclusive and 2 m inclusive starting from the first aerodynamic segment and considering that the height is positive when the second aerodynamic segment is present in a horizontal plane located above the first aerodynamic segment when the aircraft is at rest on a horizontal area.

15. A rotary-wing aircraft provided with a tail boom carrying a tail fin, the aircraft comprising a tail rotor carried by the tail fin, the tail rotor being able to rotate about a rotor axis and having a rotor diameter, a vertical-longitudinal plane passing through the tail boom transversely separating a first side from a second side of the aircraft, the aircraft comprising a pitch stabilization system that is provided with at least one pitch stabilizer that extends on the first side or on the second side, the pitch stabilizer comprising a first aerodynamic segment and a second aerodynamic segment,
wherein the first aerodynamic segment extends spanwise from the tail boom, from a first root section to a first end section, and the second aerodynamic segment extends spanwise from the tail fin, from a second root section to a second end section, the first end section being directly connected to the second end section or via a connecting segment, a trailing edge at the first root section being separated: i) longitudinally and seen from above, from a leading edge at the second root section by a longitudinal distance of between 0.5 m inclusive and 2.5 m inclusive, and ii) vertically and seen from a position behind the aircraft, by a height of between −1 m inclusive and 2 m inclusive starting from the first aerodynamic segment and considering that the height is positive when the second aerodynamic segment is present in a horizontal plane located above the first aerodynamic segment when the aircraft is at rest on a horizontal area.

16. A rotary-wing aircraft provided with a tail boom carrying a tail fin, the aircraft comprising a tail rotor carried by the tail fin, the tail rotor being able to rotate about a rotor axis and having a rotor diameter, a vertical-longitudinal plane passing through the tail boom transversely separating a first side from a second side of the aircraft, the aircraft comprising a pitch stabilization system that is provided with at least one pitch stabilizer that extends on the first side or on the second side, the pitch stabilizer comprising a first aerodynamic segment and a second aerodynamic segment,
wherein the first aerodynamic segment extends spanwise from the tail boom, from a first root section to a first end section, and the second aerodynamic segment extends spanwise from the tail fin, from a second root section to a second end section, the first end section being connected directly to the second end section or via a connecting segment, the first aerodynamic segment having a first quarter-chord line, a second quarter-chord line of the second aerodynamic segment in the second root section being longitudinally separated from a vertical-transverse rotor plane containing the rotor axis by a second longitudinal distance between 0.6 times the rotor diameter inclusive and the rotor diameter inclusive.
